(19) United States
(12) Patent Application Publication
(10) Pub. No.: US 2011/0032225 A1
(43) Pub. Date: Feb. 10, 2011

(54) SYSTEMS, METHODS, AND ARTICLES FOR MANUFACTURE FOR THE INTELLIGENT CONTROL OF DECORATIVE BODIES

(76) Inventors: Phu Dang, Shawnee, KS (US); Ka Wai Ng, Sheung Shui (CN)

Correspondence Address: SHOOK, HARDY & BACON LLP;INTELLECTUAL PROPERTY DEPARTMENT, 2555 GRAND BLVD, KANSAS CITY, MO, 64108-2613, US

(21) Appl. No.: 12/898,398

(22) Filed: Oct. 5, 2010

(51) Int. Cl. G09G 5/00; G05B 19/042; G06F 17/00; H05B 37/02

(52) U.S. Cl. 345/204; 700/23; 700/90; 315/292

(57) ABSTRACT

Decoration devices of various forms are disclosed, including decoration devices that connect with one or more decorative bodies having performances or routines. When decorative bodies are attached to decoration devices of various embodiments of the present invention, the activation and control of any performance or routine on one decoration device may result in the activation and control of any number of performances or routines on other decoration devices. Once a selection of a performance or routine is received or identified, information associated with the selection may be communicated among the decorative bodies and used to activate additional performances.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Powered Christmas ornaments have been around for some time. Traditionally, these ornaments are either battery-powered or powered through a connection with a light string. Even though several ornaments were typically connected to a common line, prior art light strings failed to facilitate communications between powered ornaments attached to the same line.

### BRIEF SUMMARY OF THE INVENTION

Embodiments of the present invention relate to a novel decoration device and decorative bodies configured to be attached to the same. Other embodiments relate to novel methods and computer-readable media having instructions relating to the activation or control of the same. More particularly, embodiments of the present invention include a decoration device that includes a number of connectors that are each attached to a shared conductive wire. Decorative bodies, such as, for example, tree ornaments, may optionally attach to the connectors according to embodiments of the present invention. When decorative bodies are so attached, communications among these attached devices may occur through the shared conductive wire. Communications may include, for example, information relating to a performance or routine to be performed. The communicated information may then be used by the other decorative bodies to identify, activate, or control associated performances or routines.

Other embodiments include, for example only, decorative bodies configured to communicate through decoration devices of various implementations of the present invention. These decorative bodies may include output elements, such as lights, audio playback devices, displays, and the like, that are activated and controlled pursuant to instructions stored in a memory. When a particular performance (or set of performances) is selected, including selections from a user, embodiments of the present invention include communicating that selection (or information associated with that selection) to one or more connected decorative bodies. The communicated information may be leveraged to identify, activate, or control associated performances or routines.

Furthermore, embodiments of the present invention relate to methods of identifying a performance, generating a signal having information associated with the identified performance, and communicating the signal to facilitate the identification, activation, and/or control of associated performances or routines. For instance, an embodiment of the present invention includes receiving a performance selection from a user, communicating that selection (directly or indirectly, including through a decoration device) to an ornament, and using the communicated information at the ornament to identify, activate, and control an associated performance. Other embodiments of the present invention include computer-readable media storing instructions relating to the various methods disclosed herein, including computer-readable media having instructions that, when executed, cause a processor to perform any of the various functions disclosed herein.

### BRIEF DESCRIPTION OF THE EXEMPLARY DRAWINGS

The features of the invention noted above are explained in more detail with reference to the embodiments illustrated in the attached drawing figures, in which like reference numerals denote like elements, in which FIGS. 1-7 illustrate one of several possible embodiments of the present invention, and in which:

FIG. 1A is a front side elevation view of an exemplary ornament in accordance with embodiments of the present invention;

FIG. 1B is a front side elevation view of the ornament of FIG. 1A with some potential interior features of the ornament revealed;

FIG. 1C is a front side elevation view of the ornament of FIG. 1A with some other potential interior features of the ornament revealed;

FIG. 1D is a front side elevation view of the ornament of FIG. 1A with additional potential interior features of the ornament revealed;

FIG. 2A is a front side elevation view of a decoration device in accordance with one embodiment of the present invention;

FIG. 2B is enlarged, fragmentary, partial cross-section view similar to FIG. 2B view of optional interior features of a potential connector device in accordance with embodiments of the present invention;

FIG. 2C is a view similar to FIG. 2B with additional potential features of a potential connector device in accordance with embodiments of the present invention;

FIGS. 3A-3C illustrate potential topologies consistent with various embodiments of the present invention;

FIG. 4A is a side elevation view of a potential decoration device having decorative bodies coupled therewith in accordance with embodiments of the present invention;

FIG. 4B is a perspective view of one centrally controlled implementation of a star topology of a decoration device in accordance with embodiments of the present invention;

FIG. 5 is a message flow diagram illustrating an exemplary message flow between decorative bodies of the decoration device illustrated in FIGS. 4A and 4B in accordance with embodiments of the present invention;

FIG. 6A is a front side elevation view of a potential decoration device having decorative bodies coupled therewith in accordance with embodiments of the present invention;

FIG. 6B is a front side elevation view of one distributed control implementation of a bus topology of a decoration device in accordance with embodiments of the present invention; and

FIG. 7 is a message flow diagram illustrating an exemplary message flow between decorative bodies of the decoration device illustrated in FIGS. 6A and 6B in accordance with embodiments of the present invention.

### DETAILED DESCRIPTION OF THE INVENTION

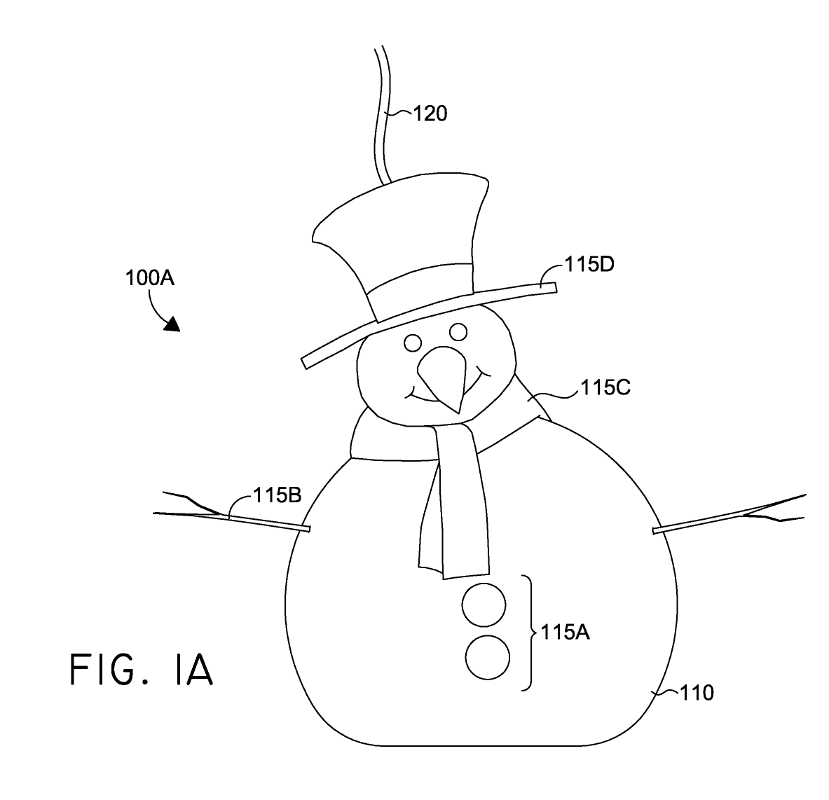

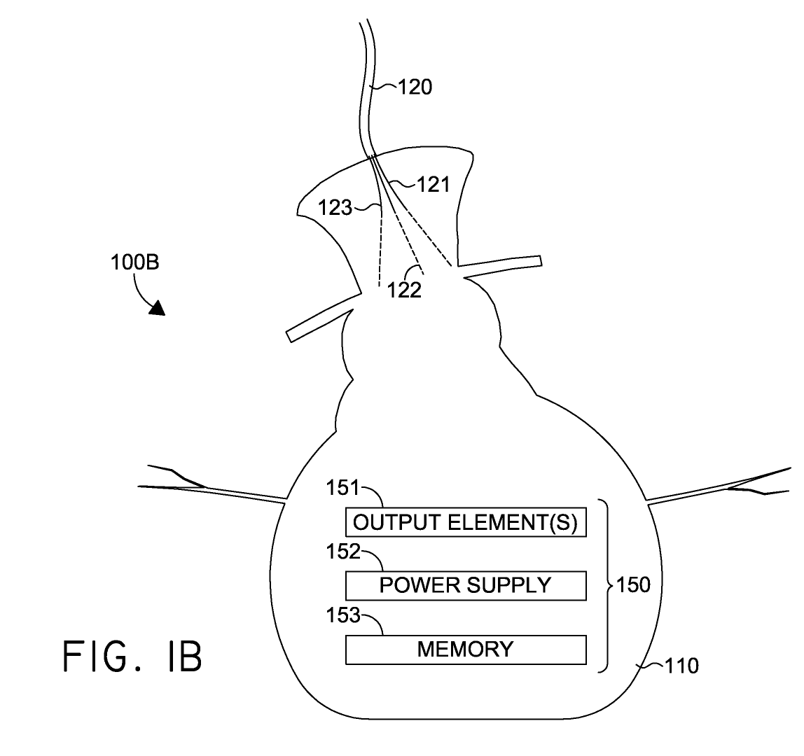

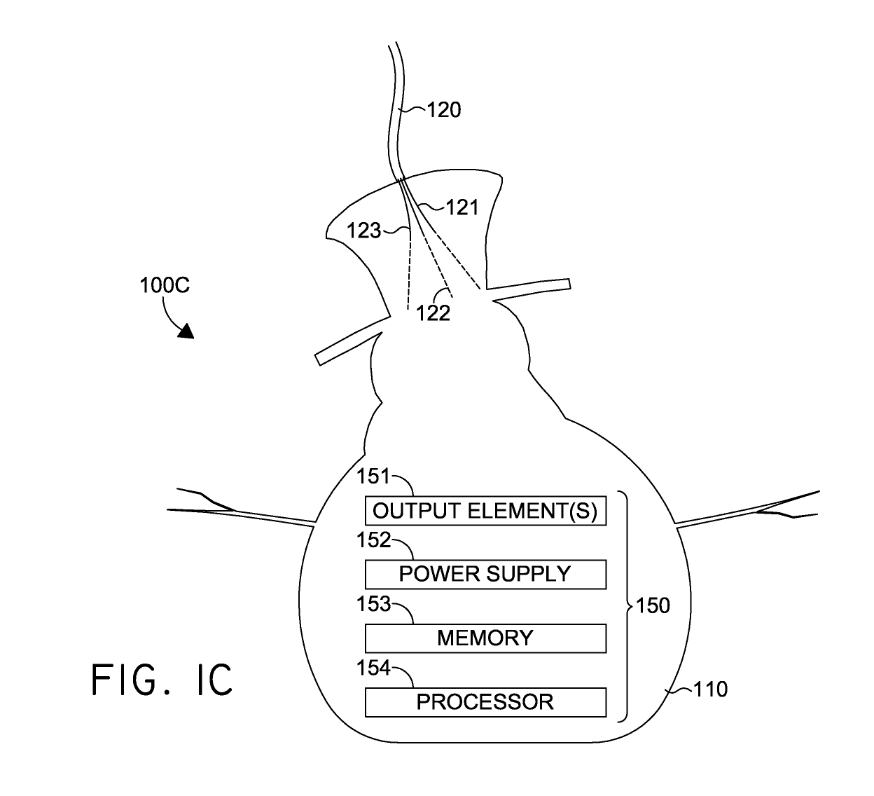

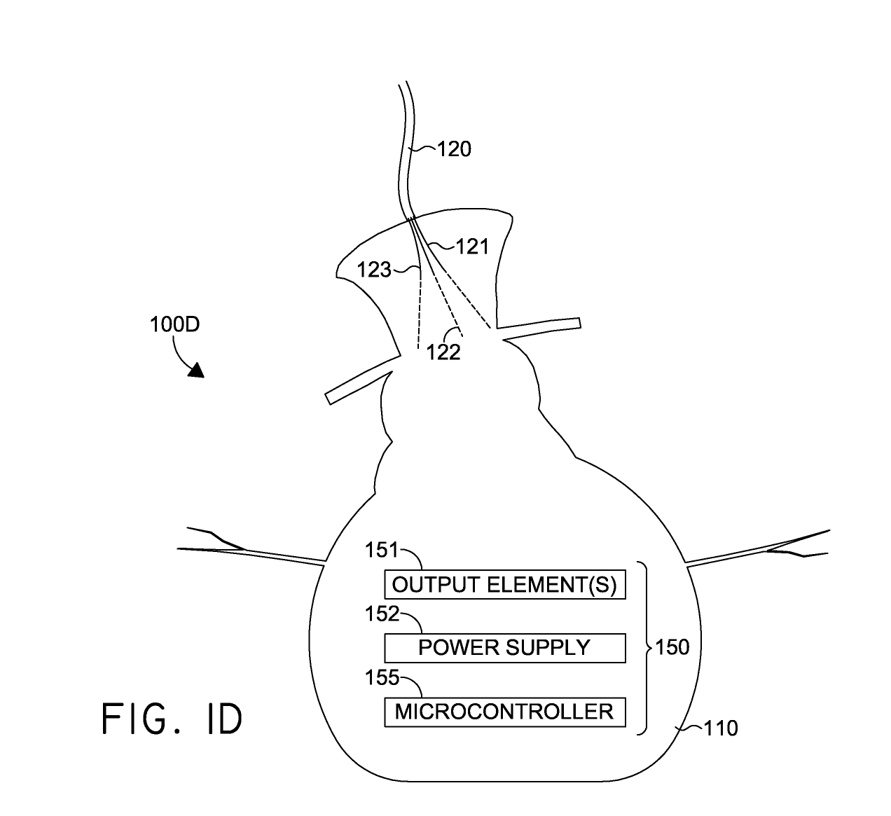

Referring now to the drawings in more detail and initially to FIG. 1A, numeral 100A generally designates an exemplary decorative body in accordance with embodiments of the present invention. In the depicted embodiment, the decorative body is an ornament (denoted as ornament 100A) that generally resembles a snowman. Ornament 100A may include, as shown in FIG. 1A, a body 110 and wiring 120. The body 110 of the ornament 100A may generally take any decorative form, including any decorative form commonly associated with tree ornaments and/or the Christmas holiday season, such as, for example, a candy cane, a Christmas tree, a Santa Claus, a wrapped present, Santa's Workshop, a sleigh or reindeer, a cross, and so on. To achieve the desired decorative form, decorative bodies of embodiments of the present invention, such as the body 110 of ornament 100A, may be constructed from any suitable material. Suitable materials may include, for example, suitable polymers (e.g., polypropylene, polyurethane, polycarbonate, polyethylene, and so on), metals (e.g., aluminum, copper, tin, nickel, silver, etc.), fabrics, plush, or any other appropriate substance (e.g., glass, wood, paper, and so on).

Regardless of the desired decorative form, decorative bodies of embodiments of the present invention, such as ornament 100A, optionally include a number of decorative flourishes. As shown in FIG. 1A, ornament 100A includes a number of flourishes, including buttons 115A, stick arms 115B, a scarf 115C, and a top hat 115D. In this regard, embodiments of the present invention include decorative flourishes associated with the desired decorative form (e.g., a candy cane, a Christmas tree, a Santa Claus, a wrapped present, Santa's Workshop, a sleigh or reindeer, a cross, and so on). The desired decorative form, as explained in more detail below, may inform the selection of output elements to enhance user interactivity and enjoyment.

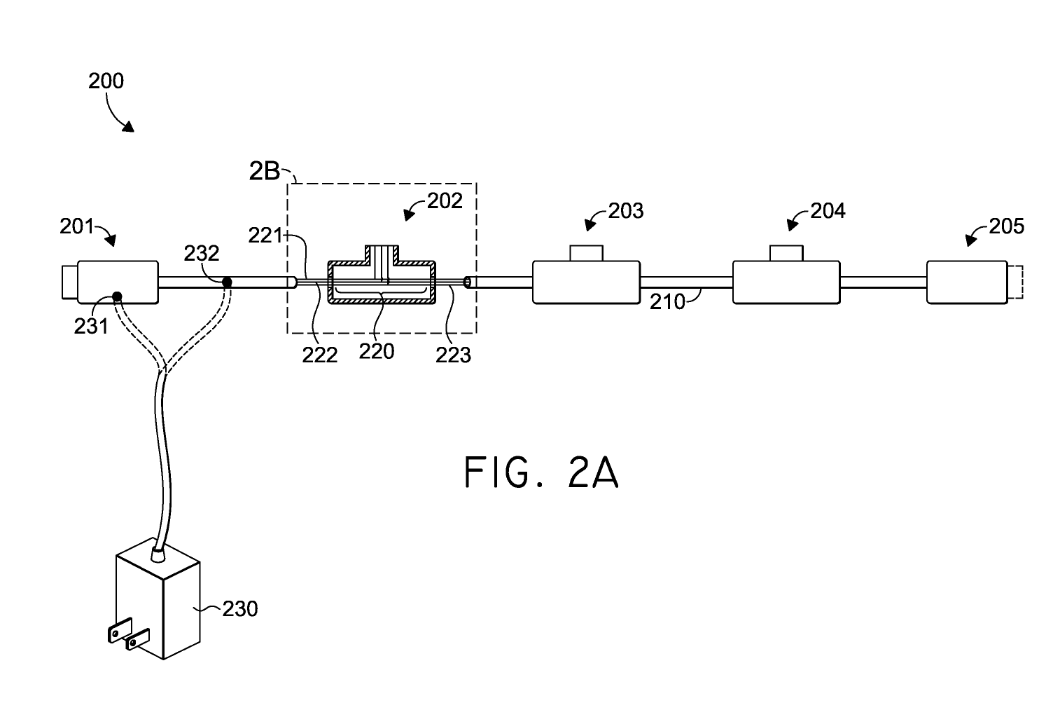

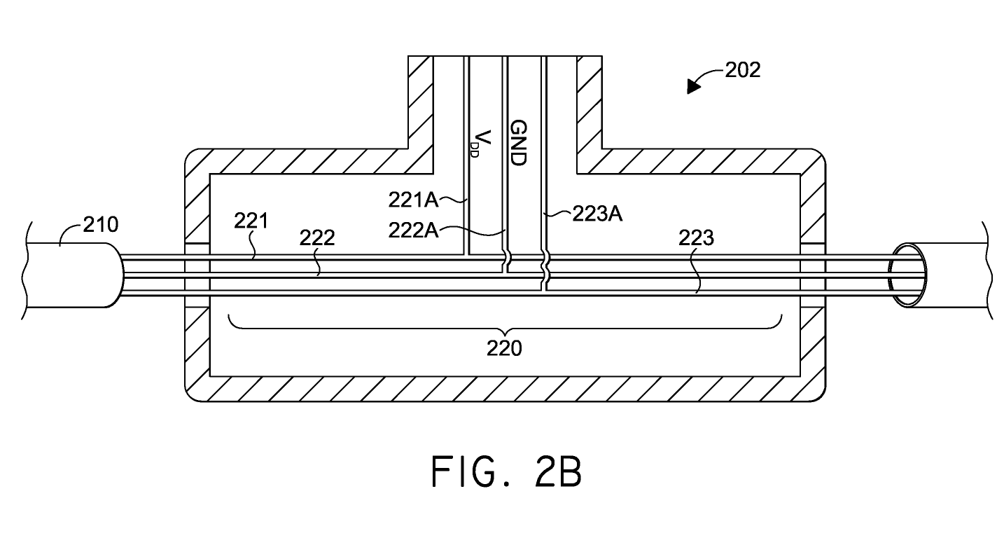

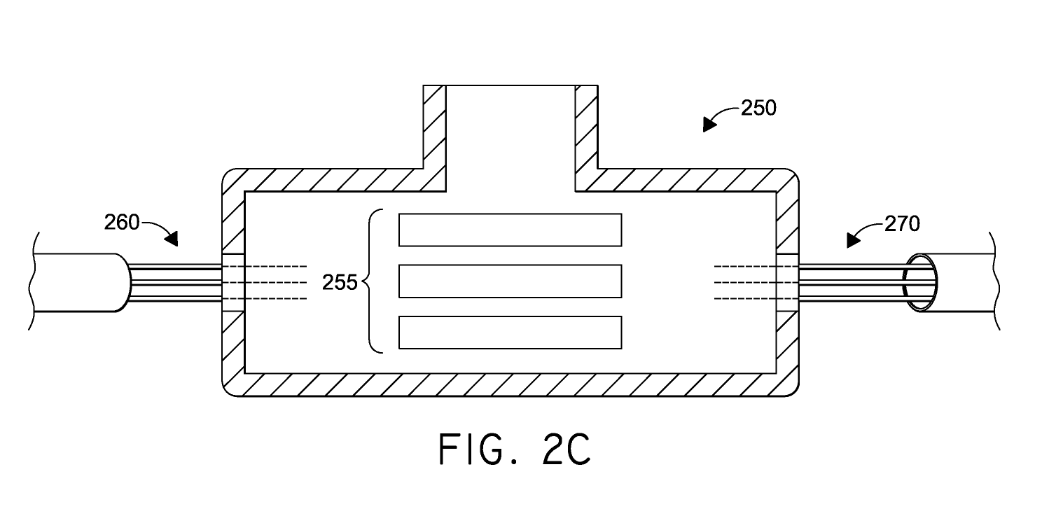

Returning again to FIG. 1A, the wiring 120 generally consists of one or more conductive wires permanently connected or releasably coupled to the body 110 and/or elements positioned, in whole or in part, therein (including, for example, internal elements 150, generally discussed below). At the other end, the wiring 120 may attach to an adaptor or similar device (not shown) for connecting or coupling with connectors (such as, for example, connectors 201, 202, 203, 204, and 205 described below and illustrated in FIG. 2A) in accordance with embodiments of the present invention. As more thoroughly explained below, embodiments of the present invention include, for example, a decoration device having a number of decorative bodies attached thereto. Consequently, in some embodiments of the present invention, decorative bodies, such as ornament 100A, may be connected to a decoration device having a number of remote elements, including, for example, a number of remote decorative bodies or remote ornaments. When a number of decorative bodies are concurrently connected to decoration devices of embodiments of the present invention, a communication link is created between the decorative bodies, as discussed below. Via this communication link, for example, decorative bodies, such as ornament 100A, may communicate with or receive messages from remote elements, such as remote decorative bodies or remote ornaments.

In another embodiment of the present invention, ornament 100A may include a user engagable switch (not shown) that can be used for powering on the ornament, such that, when the user engagable switch is engaged, ornament 100A powers on. In addition to potentially activating a decorative body, the user engagable switch may also be used to select a performance or series of performances. For example, a user could engage the user engagable switch for five seconds to power on the device and then select an intended performance via successive engagements. A first engagement after the device is powered on could, for example, indicate the selection of a random performance, while a second engagement (within a predetermined amount of time) could indicate a selection of a performance involving lights, sound, and so on. The user engagable switch may also be placed anywhere on the body 110 of ornament 100A or, in other embodiments of the present invention, on any part of the decoration device. In other embodiments, the user engagable switch may be placed anywhere in communication with a decoration device (or decorative bodies), such as, a remote control, a wireless transmitter, and the like.

In different embodiments of the present invention, selections need not be made by the user, but instead may be made by any method known in the art. For example, decorative bodies of the present invention may internally generate selections, such as, defined selections at predetermined times (e.g., activating an audio performance to play an audio file for “Silent Night” at 09:00 p.m. every day), selections at arbitrary intervals of time (e.g., activate any performance, randomly perhaps, every 12 hours), selections that occur upon detection of some external event (e.g., detecting movement through a motion detector, the application of external power, etc.), and so on. Consequently, selections of some embodiments merely indicate that a performance, set of performances, or routine should be activated and not that any particular actor has made a selection.

Turning now to FIGS. 1B-1D, several exemplary internal configurations are illustrated. Referring first to FIG. 1B, a side elevation view of the exemplary ornament depicted in FIG. 1A is provided, in which some potential interior features of the ornament are revealed. As illustrated, ornament 100B may include a permanent or releasable connection (or coupling) with wiring 120, which generally consists of one or more conductive wires. In the embodiment depicted in FIG. 1B, the wiring 120 includes a positive voltage supply line 121, a negative voltage supply line 122, and a control line 123. As would be appreciated by those of ordinary skill in the art, the positive voltage supply line 121 is commonly identified as integrated circuit supply pin labels “V_{CC},” “V_{DD},” “V₊,” or “V_{S+},” while the negative voltage supply line 122 is typically known as “Ground,” “GND,” “V_{EE},” “V_{SS},” “V₋,” “V_{S-},” or the like. These lines, that is, the positive voltage supply line 121 and the negative voltage supply line 122, may provide the voltage difference necessary to power electrical components in the decoration device and all components attached thereto.

The control line 123, on the other hand, is a connection that provides a communication link to other elements, including other decorative bodies also connected to the control line 123. Through the control line 123, the ornament 100B may send and receive communications, including signals or messages, relating to the selection or activation of a performance or routine. In the embodiment illustrated in FIG. 1B (as well as the embodiments illustrated in FIGS. 1C and 1D), the control line 123 is a conductive wire. Of course, other embodiments of the present invention include any communication medium control line 123, including, for example, wireless communication lines and the like.

As further illustrated in FIG. 1B, the ornament 100B (which reveals interior features of an exemplary decorative body, such as ornament 100A of FIG. 1A) may include a number of internally-disposed elements, such as internal elements 150. The internal elements 150 are, as previously stated, wholly or partially located within the body 110 of the ornament 100B (or even externally, as described in greater detail below. In the embodiment of FIG. 1B, the ornament 100B includes at least three internal elements 150, including one or more output element 151, at least one power supply 152, and at least one memory 153. The internal elements 150, as generally detailed below, provide a measure of interactivity to embodiments of the present invention and facilitate user enjoyment of the same.

Referring initially to the one or more output elements 151 of the ornament 100B, these components are generally responsible for interaction with the user and may include, for example, any hardware and/or software systems which visually or audibly respond to a selection, including user selections at the ornament 100B (e.g., a selection received through a user engagable switch, through a wireless communication connection, etc.), user selections at remote elements in communication with the ornament 100B (e.g., a message, an indicator, remote control, etc.), and so on. Exemplary hardware and/or software systems include a light device (or light devices), a speaker (or speakers) for playing one or more audio files, a mechanical member (or members) for movement or vibration of a decorative body, a sound receiving device that converts sound into electrical signals, a display for displaying text, images, and/or video, and so on. Any number of output elements may be selected and the selection of output elements may optionally relate to the decorative form of the ornament. For example, if the decorative body were shaped like a candy cane, red and white lights forming a helix could be selected as one type of output element 151.

Returning now to FIG. 1B, the power supply 152 may include one or more batteries (not shown) positioned, either wholly or partially, in an interior cavity of the body 110. The power supply 152 may provide power to other elements of the ornament 100B including, for example, internal elements 150. For example only, the one or more batteries (not shown) may be positioned in a battery compartment (not shown) that forms a part of a battery housing (not shown). The power supply 152 is electrically connected to or coupled with various elements of the ornament 100B, such that the power supply 152 is capable of powering those various elements when charged. The power supply 152 may also be electrically connected to or coupled with one or more conductive wires of the wiring 120, including but not limited to the positive voltage supply line 121 and the negative voltage supply line 122. In some embodiments, the one or more batteries included as part of the power supply 152 may represent a secondary power source for the ornament 100B and, as such, are rechargeable. In these embodiments, the power supply 152 (and/or one or more batteries included therein) is configured to receive power from the positive voltage supply line 121 and the negative voltage supply line 122 and to recharge. In still other embodiments, the power supply 152 is configured to detect, or receive information relating to a detection, a lack of externally-provided power and, in response to this detection, automatically provide power to the ornament 100B.

The memory 153 of FIG. 1B may be any type of computer-readable media operable to store data or information and, thus, could comprise and type of volatile or non-volatile memory medium, including random access memory (“RAM”), read only memory (“ROM”), electronically erasable programmable read only memory (“EEPROM”), combinations of the foregoing thereof, and the like. As used herein, the term “EEPROM” includes all types of electronically erasable memory, regardless of the size of the blocks of memory being erased. As such, the term includes, without limitation, all types of flash memory (e.g., NOR and NAND types). In some embodiments, the memory 153 is permanently affixed inside the body 110 of the ornament 100B, while in other embodiments the memory 153 may be removable. For embodiments in which the memory is wholly or partially removable, the memory 153 may comprise, for example, a memory card such as CompactFlash, Secure Digital (“SD”), miniSD or microSD, SmartMedia, Memory Stick, and so on. In embodiments employing, in whole or in part, rewriteable computer-readable media for the memory 153, the contents of the memory 153 may optionally be updated via any data connection, including, for example only, physical connections (e.g., conductive wiring, optical links, and the like), logical connections (e.g., radio frequency, including Bluetooth®, WiFi®, WiFi, UWB, and so on), or a combination thereof.

The memory 153 may also store, according to various embodiments of the present invention, information relating to a number of performances. According to some embodiments of the present invention, a performance may include information relating to the activation or control of an output element or a set of output elements, including, for example, one or more output elements 151. The information stored on the memory 153 (or any other memory, such as a memory in, for example, the connector 250 of FIG. 2C) may take any form. Activation information includes, for example, information or instructions concerning the type, number, or sequence of output elements to activate as part of any given performance, or the timing of any of the foregoing. For example, activation information may include, for a performance involving audio, activating a speaker and reading an audio file from memory to play through that speaker. Control information includes, by way of further example, information generally relating to the manner in which an activate output element is used, such as, the extent to which certain output elements are activated, how long an activated output element should remain active, when an activate output element should be deactivated, and so on. To continue with the previous illustration, control information could include, for example, information relating to the volume that the audio file is played through the speaker, whether the volume level is constant or varied, the amount of the audio file that is played (e.g., 15 or 30 seconds of a 60 second file), the portion of the audio file to play (e.g., from 10 to 20 seconds or from 20 to 30 seconds), and so on.

The foregoing concepts may further be illustrated through an additional example involving a performance in which light devices (e.g., LEDs, incandescent bulbs, and so on) are activated and controlled. Activation information would include, for instance, information relating to which light devices to activate. Assuming, as an example, that there are 20 separate LEDs and the selected performance only involves 10 of those light devices, the activation information would include instructions relating to the identification and activation of the 10 lights involved in the performance. Control information could include, for instance, instructions relating to when each of those 10 light devices are activated, timing instructions relating to the sequence in which each light device is activated, instructions relating to the length of time that each light is activated, voltage information that can be used to regulate the voltage supplied to any of the 10 light devices (to affect, for example, brightness), the color of each light during activation, and so on.

According to other embodiments of the present invention, some performances include information relating to an associated routine (or set of routines). In some embodiments, a routine is a collection of performances sharing a common attribute or property. For instance, several decorative bodies commonly attached to a decoration device may each have a preprogrammed performance relating exclusively to the activation and control of one type of output element, such as, the activation of lights only. Because each of these decorative bodies shares a common “lights only” performance, wherein each performance shares a common “lights only” attribute, these performances could constitute a “lights only” routine. That is, activating a “lights only” only performance on one decorative body may cause that decorative body to communicate that activation to other decorative bodies, including decorative bodies having “lights only” performances associated with the routine. In response to this communication, the other decorative bodies that share this “lights only” performance could activate the relevant performance, according to instructions relating to the routine.

In other embodiments, however, a routine is a collection of performances having one or more dissimilar or uncommon attributes or properties, or are otherwise dissimilar in some discernible way. In this embodiment, for example, activating a “lights only” performance on a first decorative body could render a “lights only” performance on a second decorative body redundant. In that case, a routine could be defined such that the activation of the “lights only” performance of the first decorative body will be associated with, for example, an “audio only” performance on the second decorative body.

With the foregoing in mind, it becomes clear that embodiments of the present invention include defining various performances and routines based on any number of criteria. For instance, performances may be associated with one another, or otherwise define a routine, based on any number of factors, as would be apparent to a person of ordinary skill in the art. In one embodiment of the present invention, performances are associated with one another based on a variable or identifier assigned to each performance (or, in other embodiments, assigned to a set of performances). In this embodiment, each performance may be assigned an alphanumeric identifier such as A, B, C, D, and so on. Upon the selection of “performance A” of a first ornament, signaling or messaging may occur resulting in the activation of other performances also identified as “performance A” on other decorative bodies. Of course, any condition may be placed on these and other routines, such that the collection of performances defining a routine may be augmented to accommodate a new performance, and so on.

Returning to the “performance A” illustration provided above, a condition could be set such that only certain performances that would otherwise qualify as a “performance A” are activated, such as, performances stored on decorative bodies after a certain date (e.g., 2010), performances stored on decorative bodies during a certain time period (e.g., 2009-2011), performances stored on decorative bodies attached to particular connectors (e.g., odd connectors, even connectors, every third connector, etc.), performances stored on decorative bodies that involve certain thematic qualities (e.g., that involve red lights, vibration, displaying still images, etc.), and so on. Alternatively, of course, activating “performance A” on a first decorative body may render other performances on other decorative bodies designated as “A” redundant. Thus, activating “performance A” on a first decorative body may, depending on the criteria selected, result in “performance B” being activated on a second decorative body and “performance G” on still a third decorative body.

Returning now to the figures, and FIGS. 1C and 1D in particular, additional configurations of the ornament illustrated in FIG. 1A are provided. Turning first to the embodiment depicted in FIG. 1C, the internal elements 150 discussed above are generally the same and, as such, will not be described again. As briefly alluded to above, embodiments of the present invention include disposing one or more internal elements outside of the body of the relevant ornament, such as, for instance, body 110 of ornaments 100B, 100C, or 100D. For example, an internal element could include a processor (e.g., element 154 of FIG. 1C) or a microcontroller (e.g., element 155 of FIG. 1D). These elements may be disposed inside of a connector associated with one or more elements, thereby facilitating various objectives of the present invention, including, for example, decentralized control, remote processor, space and resource maximization, and so on. Returning now to FIG. 1c, this embodiment, as just described, further includes a processor 154, which may be any type of processor that is capable of receiving and/or executing instructions, including instructions relating to the activation or control of output elements 151, as discussed above, or for compiling, decompiling, transmitting, or receiving information or messages. More generally, the processor 154 is configured to read any set of instructions comprising programs that perform any functions in accordance with embodiments of the present invention. For example, the processor 154 may be included in ornament 100C to read and process instructions relating to the activation or control of a performance stored in the memory 153. In some embodiments, the internal elements 150 may be physically separate, while in other embodiments include physically or logically combining one or more of the same. One example of the latter embodiment is provided in FIG. 1D, which includes a microcontroller 155 in lieu of the memory 153 and the processor 154. Like the processor 154, the microcontroller 155 may optionally include a number of input/output (“I/O”) connections that facilitate communication with and/or control of any other internal element 150, including, for example, output elements 151.

Turning now to FIG. 2A, an exemplary configuration of a decoration device in accordance with embodiments of the present invention is provided. Depicted in FIG. 2A is a decoration device 200, which has a number of attached connectors, including connectors 201, 202, 203, 204, and 205. In the illustrated example of FIG. 2A, the decoration device 200 includes five separate connectors (i.e., connectors 201, 202, 203, 204, and 205). In alternate embodiments of the present invention, the decoration device 200 may have more or less connectors depending on a variety of factors, including cost, safety issues, and so on. Similarly, even though the connectors 201, 202, 203, 204, and 205 are illustrated at equal distances, they may, of course, be separated by any distance suitable for embodiments of the present invention, including, for example, distances that vary between adjacent connectors (e.g., the distance between connector 201 and connector 202 may be greater or less than the distance between connector 202 and connector 203, and so on).

In some embodiments, the decoration device 200 may include connectors positioned at the terminal ends of cord 210 (illustrated in FIG. 2A). Terminal connectors, depicted as connector 201 and connector 205 in FIG. 2A, may optionally be configured such that they can be connected or coupled to other connectors disposed along another decoration device. In the embodiment illustrated in FIG. 2A, connector 201 may include an outwardly extending element (e.g., a “male” connector) configured to secure a connection with an inwardly defined element (i.e., a “female” connection) of connector 205 (dash outline illustrated one potential distinction; of course, the “male” and “female” distinction is not limited to the nature of the outwardly extending connection site and may refer to, for example, the actual arrangement of the pins that secure the connection between various elements of embodiments of the current invention). In this embodiment, connector 201 may be releasably connected or coupled with connector 205 of a separate decoration device (not shown), thereby allowing several decoration devices, such as the decoration device 200, to be linked in a series. In other embodiments, one (or both) of the terminal connections (e.g., connector 201 and connector 205 in FIG. 2A) may include multiple connection sites. For example, connector 201 could include one outwardly extending element that provides a connection site for an inwardly defined element of connector 205 (for “daisy-chain” implementations) and an additional element that provides a connection point for decorative bodies of embodiments of the present invention. In these embodiments, daisy-chain connections may be secured without compromising the total number of connection sites available for decorative bodies.

Returning now to FIG. 2A, the decoration device 200 includes a cord 210 that facilitates a connection between connectors 201, 202, 203, 204, and 205. The cord 210 includes a number of conductive wires 220, including a positive voltage supply line 221, a negative voltage supply line 222, and at least one control line 223. The conductive wires included in the cord 210 may, of course, be insulated or protected by any suitable material, as would be apparent to a person having ordinary skill in the art. Power is provided to the positive voltage supply line 221 and the negative voltage supply line 222 through an electrical connection with any power supply, such as any alternating current (“AC”) (e.g., a wall socket) or a direct current (“DC”) source (not shown). In one embodiment, partially illustrated in FIG. 2A, the electrical connection with an external power supply may be made through an adapter, such as adapter 230, that connects the decoration device 200, at any point, including in or at a connector (e.g., point 231 in FIG. 2A) or through a connection with one or more conductive wires of cord 210 (point 232 in FIG. 2A), to a household power supply. In some embodiments, adapter 230 is configured to convert AC power into DC power. In other embodiments, adapter 230 is configured to supply AC power directly to decoration device 200, which itself is configured to convert AC power to DC (e.g., through a microcontroller). Of course, embodiments of the present invention may also include utilizing AC power only (i.e., no AC to DC conversion).

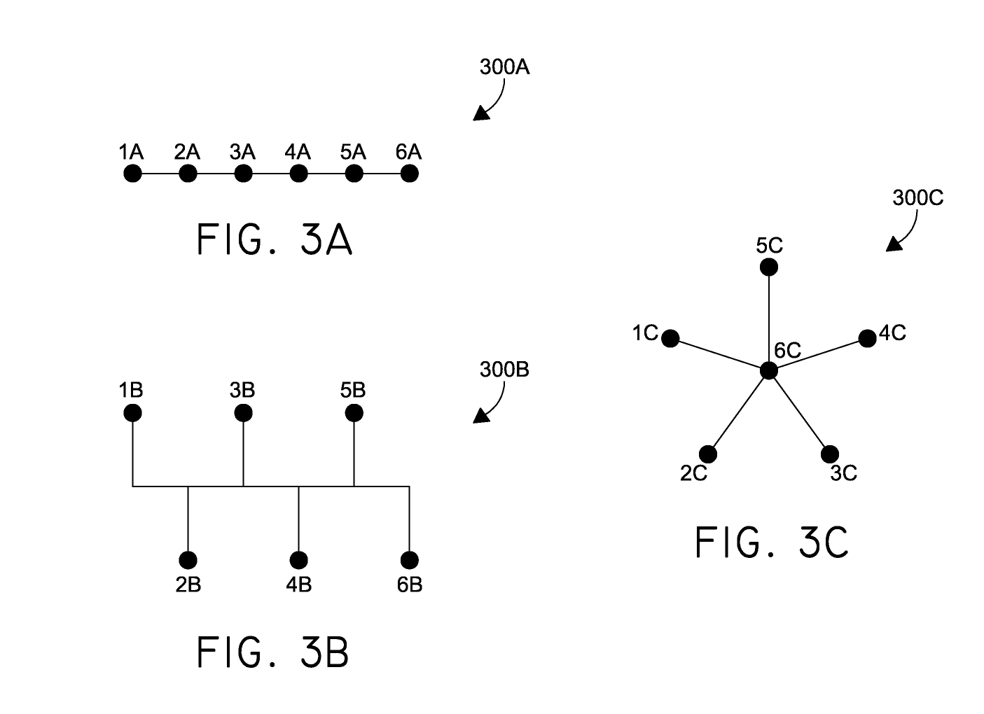

Referring now to the at least one control line 223, FIG. 2A illustrates one potential embodiment of the present invention in which only one control line is used. As explained below in connection with FIG. 3, the number and arrangement of control lines may vary according to various embodiments of the invention. For instance, in the embodiments of the present invention employing a wireless communication link, no conductive wire is necessary, as communications between decorative bodies may occur through the wireless connection. In the example illustrated in FIG. 2A, which generally corresponds to a bus topology, a single conductive wire is disclosed as the at least one control line 223. In still other embodiments, such as an embodiment utilizing a star topology, the number of control lines 223 may vary according to any number of factors, including, for example, the number of connectors or decorative bodies connected to the decorative device.

Referring now to FIG. 2B, additional details concerning the embodiment depicted in FIG. 2A are provided. As shown in FIG. 2A, the cord 210 includes a number of conductive wires 220, including the positive voltage supply line 221, the negative voltage supply line 222, and the at least one control line 223. In one embodiment, these conductive wires (or associated connections) extend into the connectors, such as connectors 201, 202, 203, 204, and 205. FIG. 2B illustrates this concept as it relates specifically to an exemplary connector (i.e., connector 202). These extensions, including line 221A, line 222A, and control line 223A, provide the conductive interfaces for connecting or joining electrical circuits in the decoration device 200 to a connected ornament (e.g., ornament 100B). For example, the positive voltage supply line 221A, the negative voltage supply line 222A, and the control line 223A may provide a connection between the positive voltage supply line 221, the negative voltage supply line 222, and the at least one control line 223 of the decoration device 200 (see FIG. 2A) and wiring 120 of the ornaments 100B, 100C, or 100D (see FIGS. 1B-1D), including the positive voltage supply line 121, the negative voltage supply line 122, and the control line 123. The decorative bodies, in accordance with embodiments of the present invention, may directly connect to the positive voltage supply line 221A, the negative voltage supply line 222A, and the control line 223A or may connect through an adapter, as previously discussed. These connections allow, for example, decorative bodies in accordance with embodiments of the present invention to draw power from a decoration device 200 and similarly facilitate communications between separate elements (e.g., separate decorative bodies or ornaments), as detailed throughout the present application.

Another potential embodiment of the present invention is depicted in FIG. 2C, which illustrates an exemplary connector 250. The connector 250 of FIG. 2C is connected to a number of conductive wires, such as those discussed above in FIGS. 1B-1D and 2A-2B (wiring 120 and/or conductive wires 220). The connector 250 further includes a number of internal elements 255, which are, in whole or in part, located within the connector 250. These internal elements 255 were generally discussed above in connection with ornaments 100B, 100C, and 100D and, therefore, may include any internal element discussed above. The internal elements 255 of the connector 250 may be, depending on a variety of factors, in addition to or in lieu of one or more internal elements 150 being placed in connected decorative bodies, such as, ornaments 100B, 100C, and 100D.

Turning now to FIGS. 3A-3C, several potential physical or logical topologies for implementing various embodiments of the present invention are provided. While three potential options are illustrated, embodiments of the present invention are not limited to only these arrangements, as would be appreciated by a person having ordinary skill in the art. Generally speaking, the exemplary topologies 300A, 300B, and 300C illustrate a number of elements (ranging from 1 to 6) that form a collection of interconnected components. These interconnections, or networks, generally facilitate communications in accordance with embodiments of the present invention. In each of the illustrated topologies, that is, in each of 300A, 300B, and 300C, the elements numbered 1 through 6 (including 1A, 2A, 3A, 4A, 5A, and 6A for exemplary topology 300A, and so on), represent decorative bodies or connectors in accordance with various embodiments of the present invention.

Turning first to the exemplary topology 300A in FIG. 3A, a point-to-point or line network is disclosed. In this arrangement, devices connected to a decoration device (e.g., 1A, 2A, and so on) communicate with one another (via messages, signaling, etc.) through adjacent elements only. That is, for example, element 1A is not directly connected, but is only indirectly connected, to element 4A and, therefore, can only communicate with element 4A through element 2A and element 3A.

Turning now to the exemplary network topology 300B in FIG. 3B, a bus topology consistent with an embodiment of the present invention is disclosed. In this embodiment, connected elements may communicate directly with other elements also connected to a shared communication line. For example, element 1B may send a message directly to element 4B (that is, it may bypass intermediary elements such as element 2B and 3B). Communications, such as signals or messages, sent from one element to any other element may be unicast, broadcast, or multicast.

Finally, referring to the exemplary topology 300C in FIG. 3C, a star topology orientation is provided. In this example, one element (shown as element 6C) is physically or logically connected to every other element connected to the decoration device. Communications transmitted over exemplary topology 300C are passed through a center element, which is illustrated in FIG. 3 as element 6C, before being communicated to the intended destination or destinations. In this embodiment, when the decoration device includes two terminal connectors capable of being releasably connected or coupled to each other (see FIG. 2A and companion description), the distinct decoration devices that form the connected network may each retain a star topology. Communications, or messages, may of course be sent from one decoration device to another decoration device via an expanded star arrangement (or “tree” topology), wherein groups of star-configured decoration device networks are connected to one another in a linear bus arrangement. As would be apparent to a person having ordinary skill in the art, the various elements of embodiments of the present invention (e.g., decorative bodies, connectors, processors, controllers, etc.) may communicate with one another in any manner, including, for instance, via direct communications (e.g., decentralized control utilizing a bus topology) or indirectly (e.g., centralized control through a fully connected mesh topology). To that end, the topologies identified in FIGS. 3A-3C and the companion description are exemplary only and, assuming information can be relayed (in whole or in part) amongst elements, no specific communication topology should be implied from FIGS. 3A-3C.

### Example 1

As described above, examples of various embodiments of the present invention may include systems, devices, and methods for intelligently controlled decoration devices. The various features of the present invention have been described in relation to various embodiments, which are intended in all respects to be illustrative rather than restrictive. Alternative embodiments will become apparent, with the benefit of the present disclosure, to those of ordinary skill in the art to which the present invention pertains without departing from its scope.

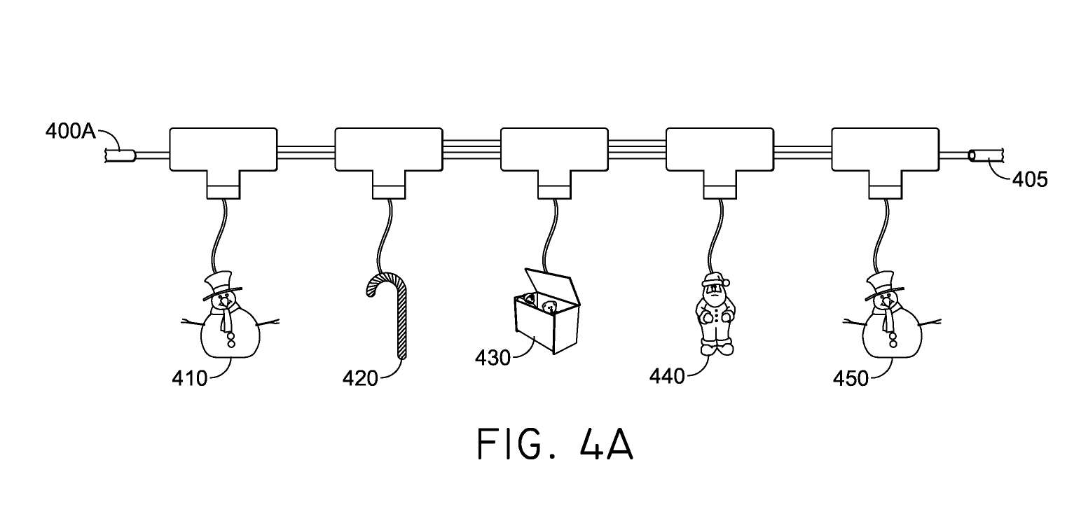

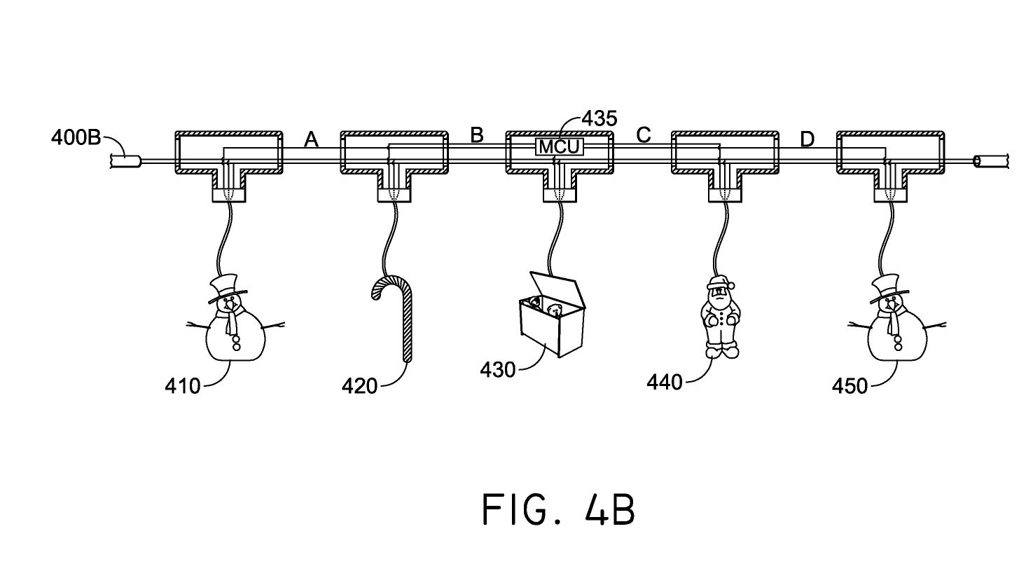

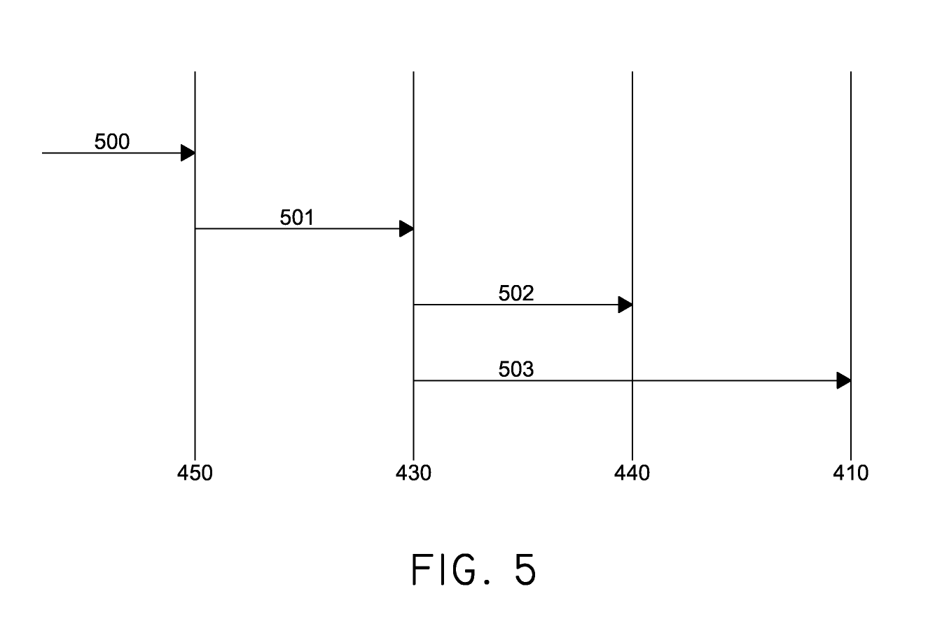

Turning to a first example, which is described below and exemplified in FIGS. 4A, 4B, and 5, embodiments of the present invention are provided. Referring to FIG. 4A, attached to a decoration device 400A are a number of ornaments, including ornaments 410, 420, 430, 440, and 450. Ornaments 410, 420, 430, 440, and 450 are connected via a line 405. For the purposes of this first specific example, each of the ornaments 410, 420, 430, 440, and 450 are generally constructed as discussed above for ornament 100D of FIG. 1D, subject to the following clarification. In particular, the ornaments 410, 420, 430, 440, and 450 each include one or more output elements, and a power supply. In this specific embodiment, there is only one microcontroller that will operate to control each ornament attached to the decoration device 400A, including ornaments 410, 420, 430, 440, and 450. There may be additional processor or microcontroller elements in other connectors or ornaments (e.g., ornaments 410, 420, 430, 440, and 450), but the identification, activation, and termination of performances in this embodiment will handled by microcontroller 435, which is disposed inside of the connector associated with decoration device 400A. In this particular embodiment, the connection sites (e.g., input/output pins) of microcontroller 435 are connected with one or more internal elements of the ornaments attached to decorative device 400A (e.g., a switch, output elements, processor, and so on). As a consequence, control of decoration device 400A may be centralized at microcontroller 435, as described in greater detail below. The output elements included in ornament 410 include, by way of example, mechanical members that make the arms of the snowman come together (i.e., that make the snowman appear to clap), several light devices (e.g., light emitting diodes (“LED”) for the eyes and buttons), a speaker and several audio files. Instructions relating to the activation and control of these output elements are stored in a memory, such as a memory component of the internal microcontroller discussed above. These instructions, as discussed above, generally define a number of performances, each relating to the activation and/or control of one or more of the output elements for ornament 410.

Table 1, reproduced below, provides an exemplary (and truncated) listing of performance types. The listing reproduced in Table 1 is intended to provide general context to embodiments of the present invention, and not to exemplify all potential implementations of the same. Further, Table 1 is not intended to imply any particular arrangement (physically or logically) for any performance. To these ends, a number of aspects of embodiments of the present invention are omitted from Table 1, such as, for example, detailed instructions relating to the activation or control of particular output elements (e.g., how long to activate a particular element, the extent to which an output element is activated, the duration of the activation, sequencing, etc.).

TABLE 1
Exemplary Performances

| Indicator | Description |
|---|---|
| A | Mechanical member(s) only |
| B | Light device(s) only |
| C | Audio device(s) only (audio file 2) |
| D | Audio device(s) only (audio file 1) |
| E | Mechanical member(s); and then |
| | Audio device(s) (audio file 1) |
| F | Audio device(s) (audio file 1); and then |
| | Mechanical member(s) |
| . | . |
| . | . |
| . | . |

Other ornaments also connected to decoration device 400A (either directly or indirectly through a releasable engagement via a connector) also include performances, some of which may share a common property or attribute with one or more of the performances detailed in Table 1. In cases where a common property or attribute is shared, those associated performances may define a routine, as discussed above. Alternatively, the selection, activation, and control of a first type of performances (e.g., audio only) may result in the selection, activation, and control of performances of a second type (e.g., audio and still images being displayed), also described above.

Turning now to FIG. 4B, the topology and control scheme for decorative device 400A is generally revealed. As illustrated, ornament 430 is connected to each of ornaments 410, 420, 440, and 450 through a number of conductive wires, labeled A, B, C, and D, respectively. The embodiment illustrated in FIG. 4B is a star topology, wherein microcontroller 435 associated with decorative device 400A facilitates the interpretation of performance selections, the identification of relevant performances and routines, and the activation and/or control of output elements on each of ornaments 410, 420, 430, 440, and 450. Even though ornaments 410, 420, 440, and 450 each include a processing device (e.g., as part of the internal microcontroller), in this embodiment microcontroller 435 facilitates all processing functionality and, therefore, controls operations along the decoration device 400A are centralized at microcontroller 435. FIG. 4B illustrates these and other aspects of this embodiment of the present invention but does not provide many additional details, for example, the positive voltage line, the negative voltage line, any optional connectors, and so on, that are not germane in this example.

Turning now to FIG. 5, a message flow diagram relating to an exemplary information exchange between ornaments connected to the decoration device 400A is revealed. At event 500, a selection is received by ornament 450 indicating, for example, the selection of a performance, a set of performances, or a routine (e.g., a user presses a play button on ornament 450). In one embodiment of the present invention, the selection may be provided by a user (e.g., a user activating an ornament and selecting a performance). In another embodiment of the current invention, however, the selection may be selected by a processing element in communication with the ornament. In the latter embodiment, the user may activate the ornament or decoration device and, after that activation, a processing element in communication with the ornament can identify and select a performance based on any number of criteria (e.g., time of day, day of the year, time since last activation, whether the device is connect to an external power supply, etc.). Because the particular implementation illustrated by this example involves centralized processing and control of remote elements (e.g., decorative bodies attached to a decoration device), the selection received at event 500 is communicated to the microcontroller 435 at event 501 (for clarification, these the figures have the event messages being received by ornaments attached to the connector sites, e.g., by ornament 430 as opposed to microcontroller 435). In some embodiments, the processing device of the activated ornament may optionally initiate a performance during the communication step described as event 501. That selection could be stand alone or could inform the selection of additional performances to activate in other ornaments. Event 501 could occur in any number of manners and could include, for example, direct communication of the selection to the microcontroller 435 (via a signal or message without any involvement of the microcontroller of ornament 450). This example could occur, for instance, via an electrical connection between the microcontroller 435 and the selection input device (e.g., output of the input device electrically connected, either directly or indirectly, to an input pin of microcontroller 435). In an alternative embodiment, the processing unit of the microcontroller associated with ornament 450, if any, may receive and process the selection and may, for example, generate and transmit a signal or message to ornament 450 at event 501. The signal or message may relay the entire selection or, in some embodiments, information necessary to identify the selection. Regardless how event 501 transpires, the selection and the communication of the same may occur as a series of bits, bytes, or characters or may occur as formatted data, for example, messages having a defined format such as a packet.

Upon receipt of the information supplied during event 501, the microcontroller 435 (which, in some embodiments, may be inside of ornament 430) processes the information to identify the selected performance. If the selected performance specifically relates to ornament 430 (e.g., a performance that only ornament 430 can perform, etc.), a signal or message could be relayed between ornament 430 and ornament 450 resulting in the activation and control of the selected performance by ornament 430 (not illustrated in FIG. 5). In the example of FIG. 5, the microcontroller 435 processes the selection to identify a plurality of performances (or, for example, an attribute of the selected performance to define a routine). The processing may involve, for example, reading data from a memory area of the microcontroller 435 or, in other embodiments, could involve the microcontroller 435 reading data stored on memories of each of the ornaments connected to decoration device 400A. Regardless how the data is accessed, in the example illustrated in FIG. 5, the microcontroller 435 identifies ornament 440 and ornament 410 as having performances associated with the selected performance (e.g., other performances of a routine associated with the selected performance). The microcontroller 435 then, in the exemplary information exchange of FIG. 5, communicates information to ornament 440 and ornament 410 concerning the selected performance (or to processing elements associated with ornaments 440 and 410, for example). These communications are illustrated as event 502 and event 503 in FIG. 5. The information communicated from ornament 430 to ornament 440 and to ornament 410 may include, by way of example, an identification of a particular performance to activate, an identification of a particular performance, an attribute associated with a performance, a routine, an attribute associated with the routine, or any other information sufficient to activate the necessary output elements of ornament 410 and ornament 440.

### Example 2

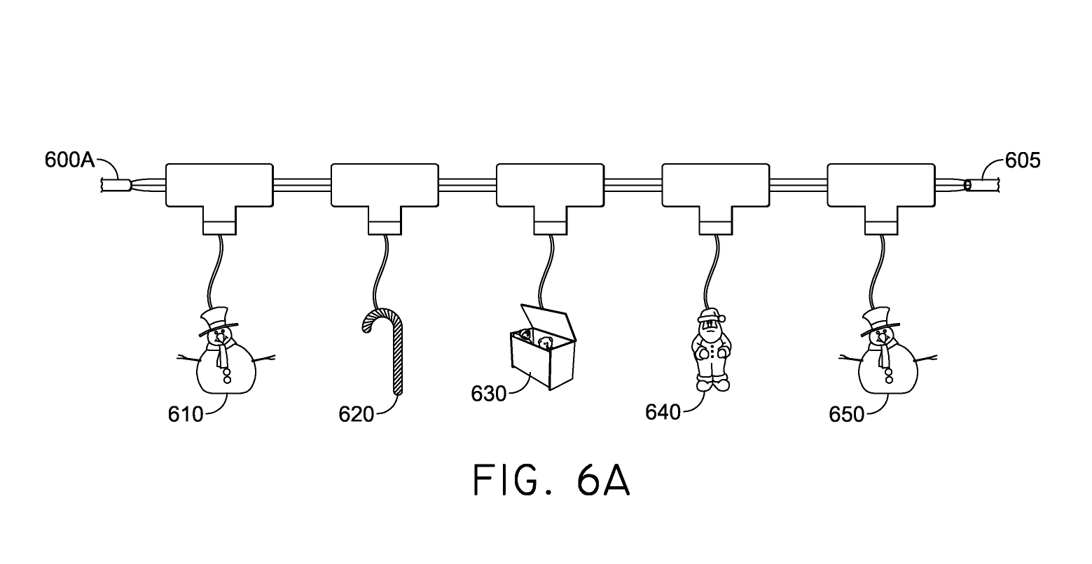

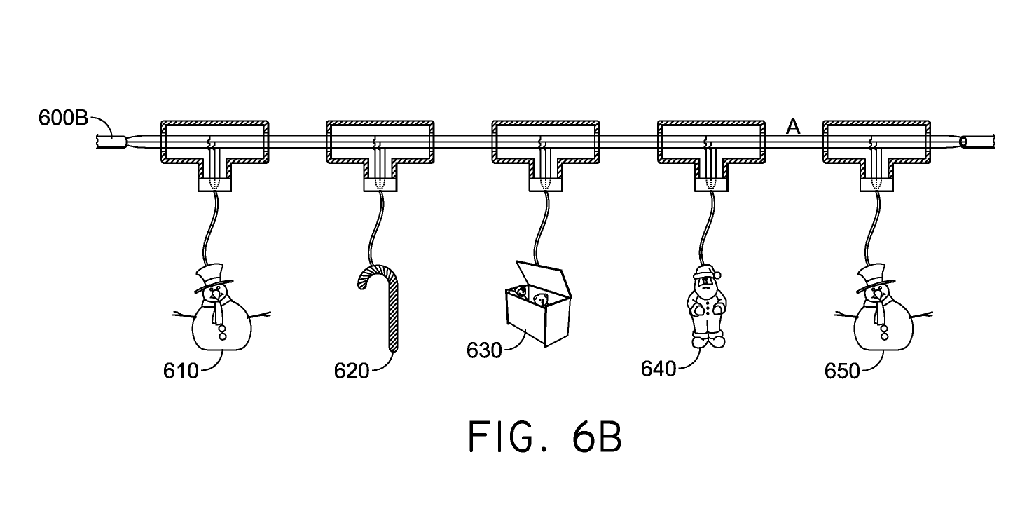

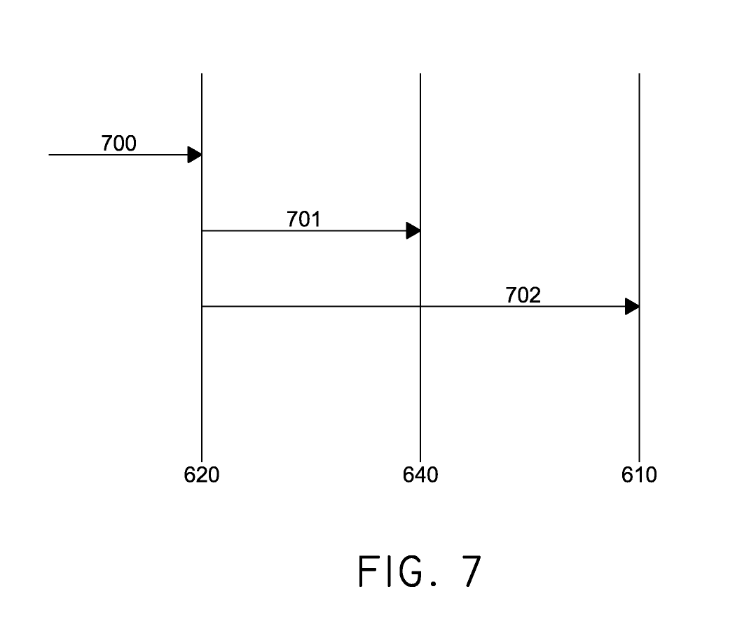

Another example of embodiments of the present invention is illustrated in FIGS. 6A, 6B, and 7. A decoration device 600A is illustrated in FIG. 6A and appears very similar to the decoration device 400A illustrated in FIG. 4A. For purposes of this example, the decoration device 600A is similar to the decoration device 400A in many ways and, therefore, a discussion of these similarities will not be reproduced in full. Like the decoration device 400A, the decoration device 600A includes a number of ornaments identified as ornaments 610, 620, 630, 640, and 650 connected via line 605. Ornaments 610, 620, 630, 640, and 650 each include one or more output elements, and a power supply. Unlike decoration device 400A, each of the ornaments attached to decoration device 600A include processing elements that identifying, activate, and terminate performances independently. In this regard, control of the ornaments attached to decoration device 600A may be described as decentralized. Continuing on, in this example, ornament 630 includes the same performances discussed above for ornament 450 (see Table 1).

As illustrated in FIG. 6B, the ornaments attached to decoration device 600B are not arranged in a star topology, but are arranged in a bus topology, that is, each ornament (or connector attached to each ornament) is connected to a shared communication line. The shared communication line is illustrated as line A in FIG. 6B. Because the ornaments 610, 620, 630, 640, and 650 share a communication line, and unlike the embodiment depicted in FIG. 4B (in which communications between ornaments, e.g., ornament 450 and ornament 410, were facilitated by ornament 430), ornaments 610, 620, 630, 640, and 650 may communication directly with one another over line A. To facilitate such communications, of course, ornaments 610, 620, 630, 640, and 650 are optionally addressable, that is, they can each individually communicate with one or more other ornaments. Additionally, the control scheme for the embodiment illustrated in FIGS. 6A, 6B, and 7 is decentralized or distributed among the ornaments implicated by the selection, as generally explained below.

Turning now to FIG. 7, a message flow diagram relating to an exemplary information exchange between ornaments connected to decoration device 600A is provided. At event 700, a selection is received by ornament 620 indicating, for example, the selection of a performance, a set of performances, or a routine. Because the particular implementation illustrated in FIG. 7 involves decentralized or distributed control, the processing and control functions of this embodiment of the invention are distributed throughout the system, including decoration device 600A, with various components thereof (e.g., decorative bodies) being individually controlled by one or more associated controllers (or processors). With regard to event 700, the selection may be processed by a processing device of the microcontroller of ornament 620. Alternatively, ornament 620 may communicate the selection (or information related to the selection) to a connector (not shown) for processing. Regardless, the selection is processed and, in this particular example, a routine for an associated performance has been selected, such as, for example, activating all performances involving mechanical member(s) only. This could include, for example, activating all performances like performance “A” in Table 1.

In this particular example, ornament 630 and ornament 650 do not have performances associated with the selected routine, i.e., they do not have any performances involving the activation of mechanical members only. Accordingly, at event 701 and event 702, ornament 620 generates and transmits a signal to ornaments 640 and 610 communicating information relating to the routine. The signal is communicated over line A, which in some embodiments of the present invention is a conductive wire. Concurrently with sending the signals identified at event 701 and event 702, ornament 620 may activate any performance or set of performances associated with the selected routine and, as explained above, may do so in accordance with instructions for the same. Upon receipt of the signal, the information related through the signal processed by processing devices in both ornament 640 and ornament 610 (or processing devices in associated connectors) to identify one or more associated performances for those ornaments. Thereafter, the relevant performances of the routine are activated and controlled according to instructions relating to the same, as discussed above.

From the foregoing it will be seen that this invention is one well adapted to attain all ends and objects hereinabove set forth together with the other advantages which are obvious and which are inherent to the method and apparatus. It will be understood that various modifications can be made and still stay within the scope of the invention. For example, decorative bodies may take on any decorative form, conductive wires may be replaced via logical or wireless connections among some or all of the connected elements, communications may occur over one or more power supply lines, and so on. It will also be understood that certain features and subcombinations are of utility and may be employed without reference to other features and subcombinations. This is contemplated by and is within the scope of the invention. Since many possible embodiments may be made of the invention without departing from the scope thereof, it is to be understood that all matter herein set forth or shown in the accompanying drawings is to be interpreted as illustrative of applications of the principles of this invention, and not in a limiting sense.

What is claimed is:

1. A device, comprising:
one or more conductive wires;
a first plurality of output elements;
a memory storing a first plurality of performances, wherein each performance in said first plurality of performances has associated instructions relating to activation or control of at least one of said first plurality of output elements;
a processor coupled to said first plurality of output elements and said memory, said processor operable to:
receive a selection identifying at least one of said first plurality of performances;
generate a signal indicating said at least one of said first plurality of performances; and
transmit said signal to a decorative body having a second plurality of output elements, wherein said decorative body activates at least one of said second plurality of output elements based on said signal.

2. The device of claim 1, wherein said signal is transmitted through at least one of said one or more conductive wires.

3. The device of claim 2, wherein said signal is transmitted as a series of bits, bytes, or characters.

4. The device of claim 2, wherein said signal is transmitted as one or more packets.

5. The device of claim 1, wherein said first plurality of output elements and said processor receive power through at least one of said one or more conductive wires.

6. The device of claim 5, further comprising:
a power supply, wherein said power supply can provide power to said first plurality of output elements and said processor when said first plurality of output elements and said processor do not receive power through at least one of said one or more conductive wires.

7. The device of claim 1, wherein said first plurality of output elements are selected from the group consisting of one or more light devices, one or more speakers for playing one or more audio files, one or more mechanical members that facilitate movement or vibration of said device, a sound receiving device that converts sound into electrical signals, and a display for displaying text, images, or video.

8. The device of claim 1, wherein said device and said decorative body are tree ornaments.

9. The device of claim 1, wherein said memory and said processor are each part of a microcontroller.

10. A device, comprising:
a first conductive wire, a second conductive wire, and a third conductive wire;
one or more output elements, wherein said one or more output elements receive power from said first conductive wire and said second conductive wire;
a memory storing a plurality of performances, each of said plurality of performances including instructions relating to activation and control of at least one of said one or more output elements;
a processor coupled to said one or more output elements and said memory, said processor operable to:
receive a signal through said third conductive wire indicating a routine;
process said signal to identify a performance associated with said routine, said performance being one of said plurality of performances;
process a first set of instructions relating to activation of an output element associated with said performance;
activate said output element associated with said performance based on said first set of instructions;
process a second set of instructions relating to the control of said output element associated with said performance; and
control said output element associated with said performance based on said second set of instructions.

11. The device of claim 10, wherein said signal is received as a series of bits, bytes, or characters.

12. The device of claim 10, wherein said signal is received as one or more packets.

13. The device of claim 10, wherein said one or more output elements are selected from the group consisting of one or more light devices, one or more speakers for playing one or more audio files, one or more mechanical members that facilitate movement or vibration of said device, a sound receiving device that converts sound into electrical signals, and a display for displaying text, images, or video.

14. The device of claim 10, wherein said device is an ornament.

15. The device of claim 10, wherein said memory and said processor are each part of a microcontroller.

16. A device, comprising:
a cord including a plurality of conductive wires;
a first connector, said first connector in electrical communication with one or more of said plurality of conductive wires and configured to connect with a first decorative body capable of activating a first plurality of performances;
a second connector, said second connector in electrical communication with one or more of said plurality of conductive wires being configured to connect with a second decorative body capable of activating a second plurality of performances; and
a microcontroller in electrical communication with said first connector and said second connector and operable to:
receive information from said first decorative body through said first connector, said information relating to a performance in said first plurality of performances;
generate a signal indicating said performance in said first plurality of performances;
transmit said signal to said second decorative body through said second connector, wherein at least one performance in said second plurality of performances is activated upon receipt of said signal.

17. The device of claim 16, wherein said signal is transmitted as a series of bits, bytes, or characters.

18. The device of claim 16, wherein said signal is transmitted as one or more packets.

19. The device of claim 16, wherein said microcontroller is located in said first connector.

20. The device of claim 16, wherein said microcontroller is located in said second connector.

21. One or more computer storage media having computer-executable instructions embodied thereon, that when executed, cause a processor to perform the following method:
receive a selection indicating a selected performance;
process said selection to identify said selected performance;
identify at least one attribute of said selected performance;
generate and transmit a first signal indicating said at least one attribute to a first ornament, wherein said first ornament receives said first signal and activates a first performance associated with said at least one attribute; and
generate and transmit a second signal indicating said at least one attribute to a second ornament, wherein said second ornament receives said second signal and activates a second performance associated with said at least one attribute.
